(19) United States
(12) Patent Application Publication
(10) Pub. No.: US 2025/0299581 A1
(43) Pub. Date: Sep. 25, 2025

(54) VEHICLE-TO-VEHICLE COMMUNICATIONS FOR BLIND SPOT NOTIFICATION

(71) Applicant: Honda Motor Co., Ltd., Tokyo (JP)

(72) Inventor: Aaron C FONG, Manhattan Beach, CA (US)

(21) Appl. No.: 18/614,299

(22) Filed: Mar. 22, 2024

(51) Int. Cl. G08G 1/16; H04W 4/46

(52) U.S. Cl. CPC G08G 1/161; G08G 1/167; H04W 4/46

(57) ABSTRACT

The present disclosure relates to systems, apparatuses and methods for vehicle-to-vehicle communications for blind spot notification. More particularly, this disclosure describes providing a flashing notification in a preceding vehicle when another vehicle passes aside of it. In an illustrative embodiment, a vehicle having a transmitter establishes a vehicle-to-vehicle communication with a preceding vehicle. An instruction or command may be provided through the established communication when the following vehicle begins its passing maneuver. After receiving the instruction, the preceding vehicle may begin to flash its headlight corresponding to the side on which the following vehicle is passing on. After the vehicle has passed the preceding vehicle, the flashing headlight may be stopped.

### BACKGROUND

In vehicle-to-vehicle (V2V) communications, vehicles may transmit information to each other through dedicated short-range communication (DSRC) devices. The information may include the position of a vehicle's whereabouts, intentions, or other useful data that may be used by vehicles surrounding it. This information may be used or developed as part of an intelligent transportation system.

The present disclosure provides for systems, apparatuses and methods for V2V communications for blind spot notifications. Other benefits and advantages will become clear from the disclosure provided herein and those advantages provided are for illustration. The statements in this section merely provide the background related to the present disclosure and does not constitute prior art.

### BRIEF DESCRIPTION

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one aspect of the present disclosure, a vehicle having a transmitter, at least one processor, and a memory operatively coupled to the processor is provided. The memory may store program instructions that when executed by the processor, causes the processor to perform processes. These processes may include a connecting with a preceding vehicle, beginning a maneuver to pass the preceding vehicle, transmitting a command to the preceding vehicle to flash at least one of its headlights, and removing the command after passing the preceding vehicle.

In accordance with another aspect of the present disclosure, a system is provided. The system may include a preceding vehicle and a following vehicle. The preceding vehicle may receive a communication from the following vehicle of its intent to pass the preceding vehicle. The preceding vehicle may flash a headlight when the following vehicle begins its passing maneuver.

In accordance with yet another aspect of the present disclosure, a method for receiving a passing maneuver by a preceding vehicle is provided. The method may include connecting with a following vehicle, receiving a command by the following vehicle intending to pass, flashing at least one headlight, and stopping the flashing of the at least one headlight when the following vehicle has passed.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES may be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a schematic diagram of an initial passing situation of a preceding vehicle in accordance with one aspect of the present disclosure;

FIG. 2 is a schematic diagram of a following vehicle passing the preceding vehicle with a flashing headlight in accordance with one aspect of the present disclosure;

FIG. 3 is a schematic diagram of the following vehicle maneuvering in front of the preceding vehicle in accordance with one aspect of the present disclosure;

FIG. 4 is a schematic diagram showing the following vehicle passing from the right side of the preceding vehicle in accordance with one aspect of the present disclosure;

FIG. 5 is a schematic diagram with the preceding vehicle having an extended flashing headlight in accordance with one aspect of the present disclosure;

FIG. 6 is a block diagram of an exemplary vehicle capable of providing vehicle-to-vehicle communications in accordance with one aspect of the present disclosure; and

FIG. 7 is a flow chart showing illustrative processes for flashing headlights of a preceding vehicle when another vehicle intends to pass it in accordance with one aspect of the present disclosure.

### DESCRIPTION OF THE DISCLOSURE

The description set forth below in connection with the appended drawings is intended as a description of exemplary embodiments of the disclosure and is not intended to represent the only forms in which the present disclosure may be constructed and/or utilized. The description sets forth the functions and the sequence of blocks for constructing and operating the disclosure in connection with the illustrated embodiments. It is to be understood, however, that the same or equivalent functions and sequences may be accomplished by different embodiments that are also intended to be encompassed within the spirit and scope of this disclosure.

The present disclosure relates to systems, apparatuses and methods for vehicle-to-vehicle communications for blind spot notification. More particularly, this disclosure describes providing a flashing notification in a preceding vehicle when another vehicle passes aside of it. In an illustrative embodiment, a vehicle having a transmitter establishes a vehicle-to-vehicle communication with a preceding vehicle. An instruction or command may be provided through the established communication when the following vehicle begins its passing maneuver. After receiving the instruction, the preceding vehicle may begin to flash its headlight corresponding to the side on which the following vehicle is passing on. After the vehicle has passed the preceding vehicle, the flashing headlight may be stopped.

Numerous other modifications or configurations to the systems, apparatuses and methods for vehicle-to-vehicle communications for blind spot notification will become apparent from the description provided below. For example, the headlight may flash depending on where the following vehicle is located. Slower flashing may indicate that the following vehicle is further behind. Advantageously, and by having the preceding vehicle flash a corresponding headlight, the driver of the vehicle may be given a warning of an oncoming vehicle and which side it is coming on. Other advantages will become apparent from the description provided below.

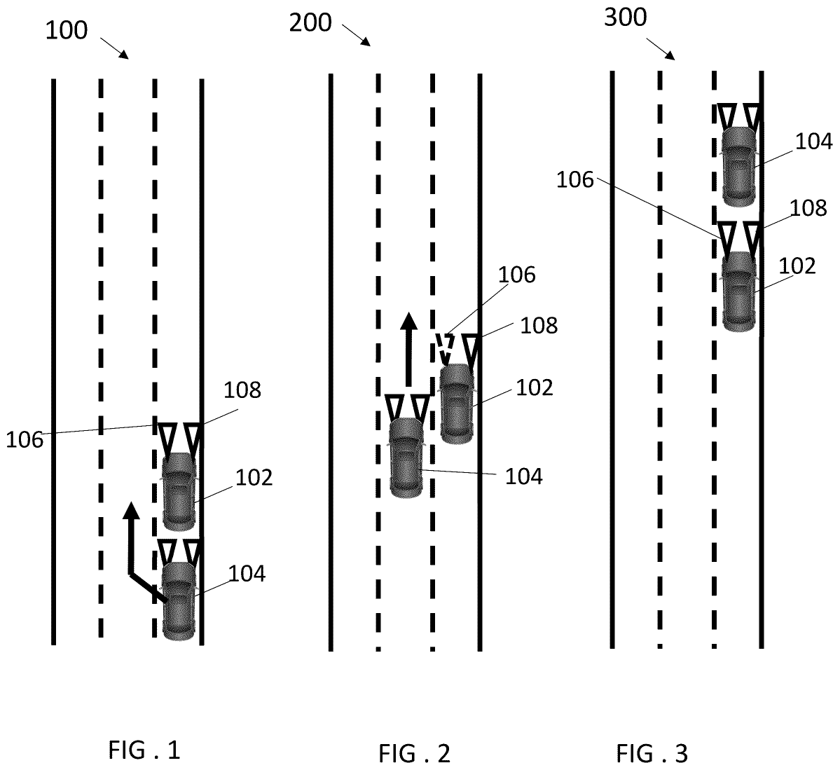

With reference now to FIG. 1, a schematic diagram 100 of an initial passing situation of a preceding vehicle 102 in accordance with one aspect of the present disclosure is provided. The diagram 100 provides a single representative situation and is not meant to be limiting to the scope of the present disclosure. Furthermore, the vehicles 102 and 104 may vary, for example, trucks, trailers, and the like may be interchanged with the vehicles 102 and 104 shown.

In the initial diagram 100, the following vehicle 104 is behind the preceding vehicle 102. The driver of the following vehicle 104 may intend to pass the preceding vehicle 102 for a variety of different reasons. For example, the preceding vehicle 102 may be moving too slow or erratically. The preceding vehicle 102 may also be exiting a freeway and has reduced its speed.

The following vehicle 104 may begin its procedure to pass the preceding vehicle 102. Typically, the following vehicle 104 may flash its blinkers. An indication of the following vehicle 104 passing may be the speed in which it is approaching the preceding vehicle 102. Using this information, an instruction or command may be sent to the preceding vehicle 102 that the following vehicle 104 is intending to pass.

A vehicle-to-vehicle communication may be established between the following vehicle 104 and the preceding vehicle 102. This may be performed manually. As an example, when the following vehicle 104 approaches the preceding vehicle 102, and a threshold distance has been established, a pop-up screen or other indicator may show up on both or either of the vehicles 102 and/or 104 requesting whether they wish to establish a communication channel. Alternatively, the communication channel between the following vehicle 104 and the preceding vehicle 102 may be established automatically. When the threshold distance is reached, the vehicles 102 and 104 may begin communicating with one another. Through the system described below, advantageously, the driver of the preceding vehicle 102 may become aware of their surroundings when their headlight 106 and/or 108 flashes.

FIG. 2 is a schematic diagram 200 of the following vehicle 104 passing the preceding vehicle 102 with a flashing headlight 106 in accordance with one aspect of the present disclosure. As shown, the following vehicle 104 has made their move to pass the preceding vehicle 102 on the preceding vehicle's left side. An instruction or command may be provided through the established vehicle-to-vehicle communication. The instruction may be a simple command providing that the following vehicle 104 is coming aside and the preceding vehicle 102 may take this instruction to start flashing its left headlight 106. Depending on the side the following vehicle 104 is approaching, the specific headlight 106 or 108 may be flashed.

In one embodiment, the preceding vehicle 102 may flash their headlight 106 depending on the speed of the following vehicle 104. For example, the headlight 106 may flash slower when the following vehicle 104 is slowly passing by or faster when the following vehicle 104 is going faster. In accordance with another embodiment, the headlight 106 may flash based on the distance between the preceding vehicle 102 and the following vehicle 104. As the following vehicle 104 comes aside the preceding vehicle 102, the flashes become shorter. Advantageously, this may indicate that the following vehicle 104 is on the preceding vehicle's side.

In one embodiment, both headlights 106 and 108 may be flashed. This may be used to alert the driver of the preceding vehicle 102 that the following vehicle 104 is coming up. Flashing the headlights 106 and/or 108 may be preferable as this would get the attention of the driver of the preceding vehicle 102. Other types of indicators or notifications may be provided. For example, information on the driver's head unit screen or dashboard may be provided on the preceding vehicle 102. Haptics or sounds may also be provided to the driver of the preceding vehicle 102 when the user passes by such as a steering wheel vibration and audial cue.

In some situations, a flashing headlight 106 or 108 may not be used even when the instruction is sent by the following vehicle 104. When appropriate, the headlight 106 or 108 may be prevented from flashing. In one example, the headlight 106 or 108 may be prevented from flashing when there are vehicles in front of the preceding vehicle 102. This may be detected through forward sensors on the preceding vehicle 102. This may remove annoyances to other drivers. Other instances where the headlight 106 or 108 may not flash may be a detection of oncoming traffic from the other side of the road. In one embodiment, the headlights 106 and/or 108 may be prevented from flashing when the user has established that they do not want this feature setup.

The flashing headlights 106 and/or 108 may turn on after the driver is on a highway or going at a certain speed, for example, 45 miles per hour. The function may also be geographical enabled. For example, if a long stretch of highway is determined from the vehicles' global positioning system, the function may be actuated.

FIG. 3 is a schematic diagram 300 of the following vehicle 104 maneuvering in front of the preceding vehicle 102 in accordance with one aspect of the present disclosure. As shown, the headlights 106 and/or 108 are no longer flashing. This would end the sequence of communication for this function. The communication channel established by the vehicle-to-vehicle communications may end. The following vehicle 104 may continue at its speed while the distance between the preceding vehicle 102 grows larger.

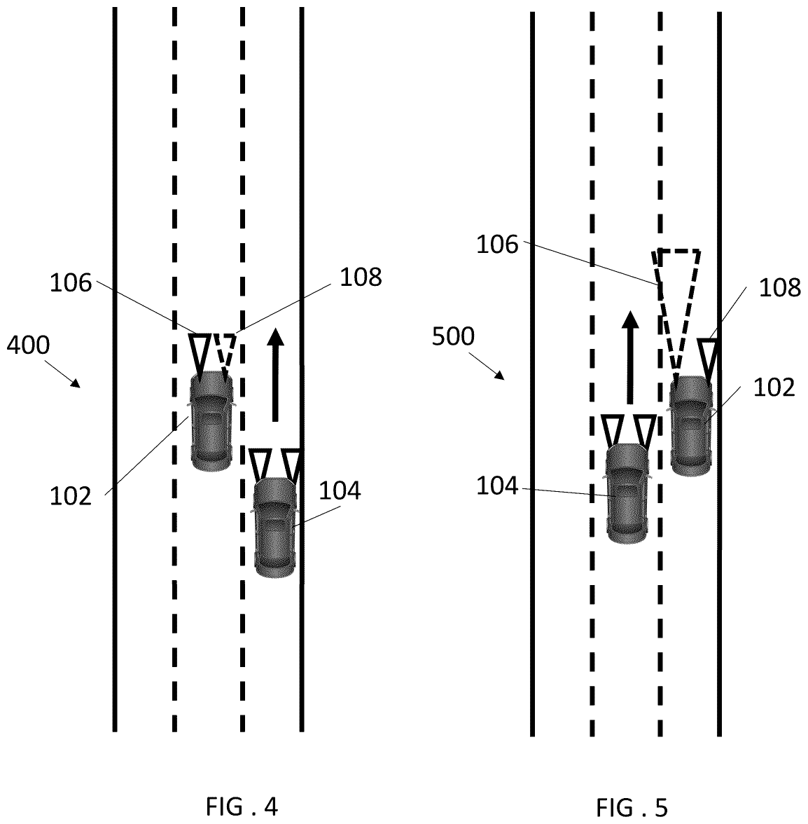

With reference to FIG. 4, a schematic diagram 400 showing the following vehicle 104 passing from the right side of the preceding vehicle 102 in accordance with one aspect of the present disclosure is provided. In this variation from the previous diagrams, the right headlight 108 may be flashed on the preceding vehicle 102 based on the following vehicle 104 passing to the right side of the preceding vehicle 102.

Similar to before, the flashing of the right headlight 108 of the vehicle 102 may be dependent on the speed or distance of the following vehicle 104. Other similar functions to those of the left head light 106 which were described above may be implemented similarly to the right headlight 108.

FIG. 5 is a schematic diagram with the preceding vehicle 102 having an extended flashing headlight 106 in accordance with one aspect of the present disclosure. Advantageously, the larger flashing of the headlight 106 may be more noticeable to the driver of the vehicle 102. The flash of the headlight 106 may have a larger field-of-view in some instances. In another shown example, the flashing headlight 106 has been extended. For example, the range of the headlight 106 may be displayed further down the road extending what is visible to the driver of the vehicle, thereby alerting the driver of the preceding vehicle 102 of the upcoming following vehicle 104.

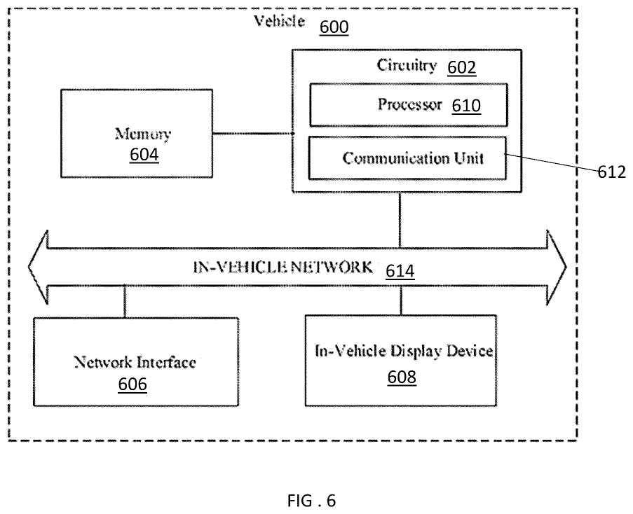

FIG. 6 is a block diagram of an exemplary vehicle 600 capable of providing vehicle-to-vehicle communications in accordance with one aspect of the present disclosure. The exemplary vehicle 600 may be representative of the preceding and following vehicles described beforehand. The vehicle 600 may include circuitry 602. The circuitry 602 may be implemented as part of an electronic control unit (ECU) which may include at least a microprocessor and/or a memory. The vehicle 600 may further include a memory 604, a network interface 606 and an in-vehicle display device 608.

The circuitry 602 may further include a processor 610 and a communication unit 612. The processor 610 may be microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

The circuitry 602 may include any number of processors configured to, individually or collectively, perform or direct performance of any number of operations of the vehicle 600, as described in the present disclosure. Additionally, one or more of the processors 610 may be present on one or more different electronic devices, such as different servers. In some embodiments, the circuitry 602 may be configured to interpret and/or execute program instructions and/or process data stored in the memory 604 and/or a persistent data storage. In some embodiments, the circuitry 602 may fetch program instructions from a persistent data storage and load the program instructions in the memory 604. After the program instructions are loaded into the memory 604, the circuitry 602 may execute the program instructions. Some of the examples of the circuitry 602 may be a Graphical Processing Unit (GPU), a Central Processing Unit (CPU), a Reduced Instruction Set Computer (RISC) processor, an Application-Specific Integrated Circuit (ASIC) processor, a Complex Instruction Set Computer (CISC) processor, a co-processor, and/or a combination thereof.

Each of such communication units 612 may be configured to handle V2X communications of the respective vehicle 600. The V2X communication may correspond to one or more of vehicle-to-infrastructure (V2I) communication, vehicle-to-network (V2N) communication, vehicle-to-vehicle (V2V) communication, vehicle-to-pedestrian (V2P) communication, vehicle-to-device (V2D) communication, or vehicle-to-grid (V2G) communication.

The vehicle 600 may further include an in-vehicle network 614 to facilitate communication between internal components of the vehicle 600. The vehicle 102 may also include other suitable components or systems, in addition to the components or systems illustrated herein to describe and explain the function and operation of the present disclosure. A description of such components or systems is omitted herein for the sake of brevity.

The circuitry 602 may include suitable logic, circuitry, and/or interfaces that may be configured to execute program instructions associated with different operations to be executed by the vehicle 600. The circuitry 602 may include any suitable special-purpose or general-purpose computer, computing entity, or processing device including various computer hardware or software modules and may be configured to execute instructions stored on any applicable computer-readable storage media. For example, the circuitry 602 may include a microprocessor, a microcontroller, a DSP, an ASIC, a FPGA, or any other digital or analog circuitry configured to interpret and/or to execute program instructions and/or to process data.

The memory 604 may include suitable logic, circuitry, interfaces, and/or code that may be configured to store the program instructions executable by the circuitry 602. In certain embodiments, the memory 604 may be configured to store operating systems and associated application-specific information.

The network interface 606 may include suitable logic, circuitry, interfaces, and/or code that may enable communication between the vehicle 600 and each of the group of electronic devices, via a wireless communication network. The network interface 606 may implement known technologies to support wired and/or wireless communication. The network interface 606 may include, but is not limited to, an antenna, a frequency modulation (FM) transceiver, a radio frequency (RF) transceiver, one or more amplifiers, a tuner, one or more oscillators, a digital signal processor, a coder-decoder (CODEC) chipset, a subscriber identity module (SIM) card, and/or a local buffer.

The in-vehicle display device 608 may include suitable logic, circuitry, interfaces, and/or code that may be configured to render various types of information and/or viewable content via a user interface (UI) of the vehicle 600. The UI may be a customizable or a non-customizable Graphical UI that may display various types of information related to the vehicle 600. Examples of the in-vehicle display device 608 may include, but are not limited to, a display of the infotainment head unit, a projection-based display, a see-through display, and/or an electro-chromic display. In an embodiment, the in-vehicle display device 608 may be implemented as one of, but not limited to, Multi-Information Display (MID), an automotive Head-Up Display (HUD), or an instrument cluster.

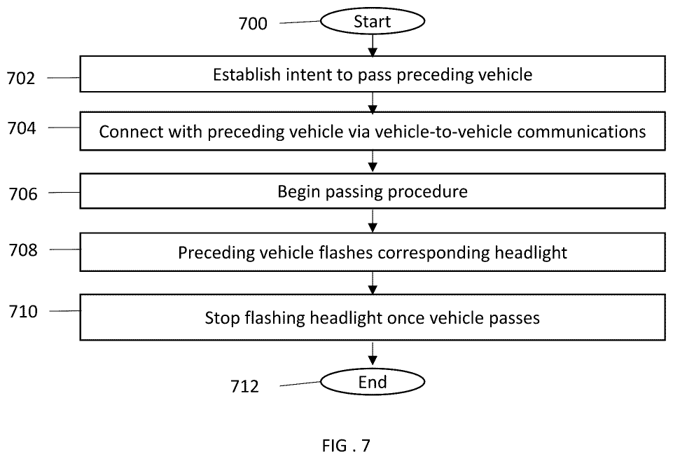

FIG. 7 is a flow chart showing illustrative processes for flashing headlights of a preceding vehicle when another vehicle intends to pass it in accordance with one aspect of the present disclosure. Fewer or more processes may be used and these are provided for illustrative purposes. It may be understood that variations of these processes may be used in light of the discussion provided above. The processes may begin at block 700.

At block 702, a following vehicle may establish an intent to pass a proceeding vehicle. This may be communicated in several forms. For example, sensors on the preceding vehicle may indicate a high rate of an incoming following vehicle, or vice versa. Through these indications an intent may be established. In one embodiment, the intent may be indicated when the following vehicle uses their blinkers and may be combined with the speed it is approaching the preceding vehicle. When the driver of the following vehicle uses their left blinker and they are traveling at a higher speed of travel than the preceding vehicle, this may indicate an intent that they are passing.

In one embodiment, the intent to pass the preceding vehicle may be manually performed. For example, a display on the following vehicle may be shown asking whether the driver intends to pass the preceding vehicle.

At block 704, once the intent has been established, a vehicle-to-vehicle connection with the preceding vehicle may be implemented. This may be performed through a variety of technologies as those described above. For example, dedicated short-range communication (DSRC) devices may be used between the vehicles. Information and other data may be passed between the vehicles once the connection has been established. The connection may be established directly from vehicle-to-vehicle. In one embodiment, the vehicles may use surrounding infrastructure to communicate with one another. The vehicles may communicate with surrounding wireless communication devices which may in turn communicate with the other vehicle.

The following vehicle may begin its passing procedure at block 706. This procedure may be monitored by both vehicles through sensors on each vehicle and/or communications back and forth. The passing procedure may also be indicated by the following vehicle using their turn signal. This may indicate to the preceding vehicle that they are about to pass.

At block 708, the preceding vehicle may begin to flash at least one of its headlights as the following vehicle passes. A single headlight may be flashed in the preceding vehicle depending on the side it is being passed. The flashes may be based on a distance and/or speed the following vehicle. A longer flash with a larger field-of-view or range may be used. In addition, both headlights may be flashed. The flashing may be prevented in some instances as indicated above. Advantageously, the driver of the preceding vehicle may be given a brief warning that they are being passed and this may server as an alert to them.

At block 710, the at least one flashing headlight may be stopped when the following vehicle passes. Sensor measurements may be taken from both vehicles to determine when the following vehicle has passed. Passing may be defined as when the following vehicle is past a predetermined distance from the preceding vehicle, for example. The processes may end at block 712.

The foregoing description is provided to enable any person skilled in the relevant art to practice the various embodiments described herein. Various modifications to these embodiments will be readily apparent to those skilled in the relevant art and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A vehicle comprising:
a transmitter;
at least one processor; and
a memory operatively coupled to the processor, the memory storing program instructions that when executed by the processor, causes the processor to:
connect with a preceding vehicle;
begin a maneuver to pass the preceding vehicle;
transmit a command to the preceding vehicle to flash at least one of its headlights;
remove the command after passing the preceding vehicle.

2. The vehicle of claim 1, wherein the transmitter comprises a network interface.

3. The vehicle of claim 2, wherein the network interface communicates the command through a non-vehicle infrastructure and the non-vehicle infrastructure relays the command to the preceding vehicle.

4. The vehicle of claim 2, wherein the network interface communicates the command through a vehicle-to-vehicle communication with the preceding vehicle.

5. The vehicle of claim 1, wherein the beginning of the maneuver comprises a blinker indication by the vehicle along with sensor readings.

6. The vehicle of claim 1, wherein the beginning of the maneuver comprises a visual intent selected on an in-vehicle display device.

7. The vehicle of claim 1, wherein transmitting the command to the preceding vehicle comprises indicating on which side the vehicle will passing the preceding vehicle.

8. The vehicle of claim 7, wherein a headlight of the at least one headlight flashes based on the side the vehicle will pass.

9. The vehicle of claim 1, wherein the preceding vehicle flashes the at least one of its headlights when appropriate.

10. A system comprising:
a preceding vehicle; and
a following vehicle, wherein the preceding vehicle receives a communication from the following vehicle of its intent to pass the preceding vehicle, the preceding vehicle flashing a headlight when the following vehicle begins its passing maneuver.

11. The system of claim 10, wherein the preceding vehicle and following vehicle communicate via vehicle-to-vehicle communications.

12. The system of claim 10, wherein flashing the headlight comprises flashing a corresponding headlight based on a side which the following vehicle is passing the preceding vehicle.

13. The system of claim 10, wherein a beam of the headlight is extended and flashed when the following vehicle is passing.

14. The system of claim 10, wherein the flashing of the headlight stops when the following vehicle passes the preceding vehicle.

15. A method for receiving a passing maneuver by a preceding vehicle comprising:
connect with a following vehicle;
receive a command by the following vehicle intending to pass;
flash at least one headlight; and
stop flashing the at least one headlight when the following vehicle has passed.

16. The method for communicating a passing maneuver of claim 15, wherein the connection occurs through a vehicle-to-vehicle communication.

17. The method for communicating a passing maneuver of claim 15, wherein stopping the flashing of the at least one headlight when the following vehicle has passed comprises detecting when the following vehicle has passed through sensors.

18. The method for communicating a passing maneuver of claim 17, wherein the sensors are located on the front of a preceding vehicle.

19. The method for communicating a passing maneuver of claim 15, wherein flashing the at least one headlight comprises flashing a headlight of the at least one headlight based on a side the following vehicle is passing.

20. The method for communicating a passing maneuver of claim 15, wherein the flashing of the at least one headlight is flashed when appropriate.
